(19) United States
(12) Patent Application Publication
(10) Pub. No.: US 2014/0327550 A1
(43) Pub. Date: Nov. 6, 2014

(54) Warning alert system for induced AC on pipeline systems for crew safety

(71) Applicants: Mark John Byerley, SR., Chino, CA (US); Roman Chak, North Hollywood, CA (US); Peter Harkins, Glendale, CA (US)

(72) Inventors: Mark John Byerley, SR., Chino, CA (US); Roman Chak, North Hollywood, CA (US); Peter Harkins, Glendale, CA (US)

(21) Appl. No.: 13/887,125

(22) Filed: May 3, 2013

(51) Int. Cl. G08B 21/02

(52) U.S. Cl. CPC G08B 21/02
USPC 340/660

(57) ABSTRACT

This invention relates to the pipeline safety system. The invention is a warning alert system for presence of an induced AC voltage/current on a pipeline system that runs in parallel with an AC transmission line. This invention is a warning alert system for ground faults from power high voltage AC systems which can induce AC voltage/current onto a piping system.

This invention relates to the pipeline safety system. The invention is a warning alert system for presence of an induced AC voltage/current on a pipeline system that runs in parallel with an AC transmission line. This invention is a warning alert system for ground faults from power high voltage AC systems which can induce AC voltage/current onto a piping system.

### FIGURE DESCRIPTIONS

FIG. 1 The device installation.

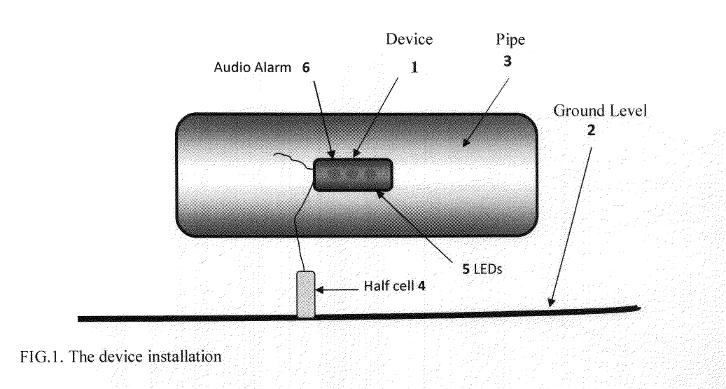

FIG. 2 The circuit diagram.

### BACKGROUND OF THE INVENTION

The invention is a warning alert system for presence of an induced AC voltage/current on a pipeline system that runs in parallel with an AC transmission line. This invention is a warning alert system for ground faults from power high voltage AC systems which can induce AC voltage/current onto a piping system. An external box or some other type of an attachment will be connected to a pipe and ground. The device will constantly or periodically monitor AC voltage levels on the pipe of interest. Once dangerous voltage levels are detected the device will set off visual and audible alarms to notify the personal.

The proposed device will be installed on a above ground pipe. Reference is now made to The device installation:

1. The warning alert system.

2. Ground level

3. Pipe

4. CuCuSO4 half cell.

5. Visual alarm “LEDs”

6. Audio alarm

The induced AC warning system input is high impedance rectified input stage. The AC voltage is sensed via two connection cables. One of then is attached to a pipe another one to a reference half cell. AC voltage is conducted into the device via the cables. The first level of the input circuit rectifies and filters the incoming waveform. Then it gets buffered and compared to known reference voltage. Once the potential difference between pipe and reference electrode goes above this threshold level the instrument sets off the audible and visual alarms.

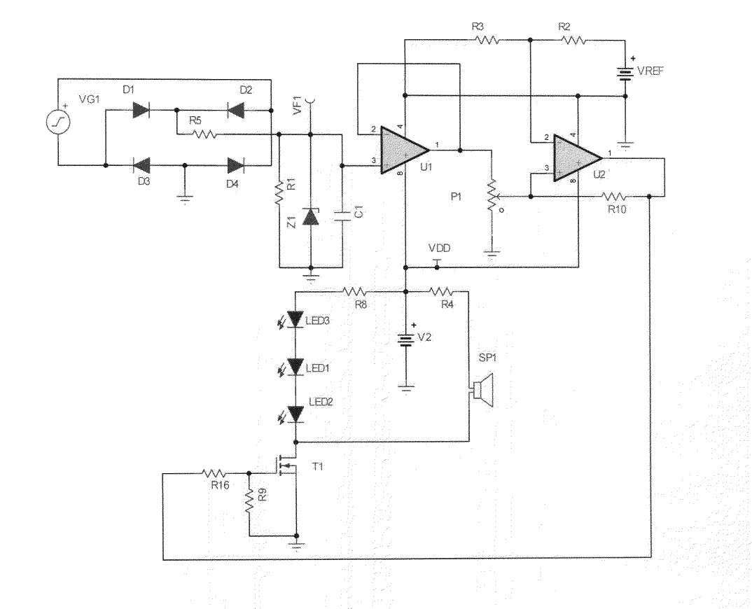

Reference is now made to FIG. 2. The input circuit consists of:

1. Input diode bridge, D1-D4

2. Input filter circuit

3. Buffer amplifier

4. Reference voltage

5. Comparator circuit

6. MOSFET driver

7. LEDs

8. Audio alarm

The invention claim is:

1. The warning alert system for induced AC on a pipeline system will monitor AC voltages/currents on a pipe and produce visual and audible alarms when induced AC voltage is at a life threatening level. It will produce visual and audible alarm in an instance of a ground fault from a power high voltage. The alarm is intended to warn working personal of a potential high voltage present on a pipe.
